(19) United States
(12) Patent Application Publication
(10) Pub. No.: US 2021/0321644 A1
(43) Pub. Date: Oct. 21, 2021

(54) MANUFACTURE OF CARBONATED BEVERAGES

(71) Applicant: KRONES AG, Neutraubling (DE)

(72) Inventors: Markus WEIGL, Regensburg (DE); Erwin ENGEL, Donaustauf (DE); Christoph HANS SCHERER, Regensburg (DE); Roland FEILNER, Regensburg (DE); Johanna JUSTL, Sinzing (DE); Thomas OEHMICHEN, Regensburg (DE); Volker RICHTER, Baernau (DE)

(21) Appl. No.: 17/209,032

(22) Filed: Mar. 22, 2021

(30) Foreign Application Priority Data
Apr. 17, 2020 (DE) 102020110502.9

(51) Int. Cl. A23L 2/54; A23L 2/76; B01F 3/04; B01F 3/22; B01F 15/00; B67C 3/20; B67C 3/00

(52) U.S. Cl. CPC A23L 2/54; A23L 2/76; B01F 3/04808; B01F 3/2223; B01F 3/2284; B01F 15/0022; B67C 2003/226; B67C 3/007; A23V 2002/00; B01F 2003/049; B01F 2003/04921; B01F 2215/0022; B67C 3/20

(57) ABSTRACT

The present invention provides a method for the manufacture of a carbonated beverage, including the steps of: providing oxygen-reduced water; mixing the oxygen-reduced water with a mixing component to obtain a beverage mixture, adding a gas comprising CO₂ to the beverage mixture to obtain a beverage mixture mixed with CO₂, reducing the oxygen content of the beverage mixture mixed with CO₂ in a first container to obtain an oxygen-reduced beverage mixture mixed with CO₂, discharging the oxygen-reduced beverage mixture mixed with CO₂ from the first container, determining the CO₂ content of the oxygen-reduced beverage mixture mixed with CO₂; and adding further CO₂ to the discharged oxygen-reduced beverage mixture mixed with CO₂ on the basis of the determined CO₂ content to obtain a finally carbonated beverage.

### CROSS REFERENCE TO RELATED APPLICATION

The present application claims priority to German Patent Application No. 102020110502.9 filed on Apr. 17, 2020. The entire contents of the above-listed application is hereby incorporated by reference for all purposes.

### TECHNICAL FIELD

The present invention relates to the manufacture of beverages, in particular low-oxygen, carbonated beverages.

### PRIOR ART

In filling lines for beverages, containers, for example bottles, cans etc., are treated in a plurality of successive process steps. Here, the process steps are in general performed in separate treatment stations which can be combined, for example, as modules of one common plant concept. A container treatment plant for glass bottles or plastic bottles, e.g. of polyethylene terephthalate (PET), polypropylene (PET) etc., can comprise, for example, a blow moulding means, a filling device, a carbonation device, a closing device, a labelling device, a packaging device, a cleaning device, a pasteurisation device, an inspection device etc. as separate, modularly designed treatment stations. The individual treatment stations, which perform successive process steps, are in general connected in series one behind the other, one or several transport devices providing the transport of the containers from the treatment stations to the respective downstream treatment stations.

It is getting increasingly important in beverage production to reduce the oxygen content or, in general, the foreign gas proportion, for example nitrogen or air, to in particular clearly extend the durability of the filled beverages and avoid chemical reactions with the pack (in particular can) as well as problems during the filling process. Moreover, higher filling temperatures can be permitted in this way, involving lower costs for cooling. Some beverages, for example beer and soda pops, are mixed with carbon dioxide. The open-loop/closed-loop control of the degassing for oxygen reduction and of the carbonation, however, involve problems in view of the complexity of the process operations and the precision and reliability of the achieved values for the degree of oxygen reduction and carbonation. For example, in the manufacture of beverages with syrup, oxygen is typically introduced by adding the syrup, after the degassing of water to the degassed water. Very high amounts of required stripping gases or a relatively high, undesired oxygen content which can lead to a bursting of the cans and an impaired quality during storage when the beverage is packaged into (coated) cans pose particular problems.

It is the object underlying the invention to provide a, compared to prior art, more reliable and efficient manufacture of carbonated beverages with a well-controlled, reduced oxygen content and with a well-controlled CO₂ content.

### BACKGROUND AND SUMMARY

The above-mentioned object is achieved by providing a method for the manufacture of a carbonated beverage, the method including the steps of:

providing oxygen-reduced water;

mixing the oxygen-reduced water with a mixing component (for example syrup, concentrate, or flavours) to obtain a beverage mixture;

adding a gas comprising CO₂ (and which can, for example, comprise N₂) to the beverage mixture to obtain a beverage mixture mixed with CO₂;

reducing the oxygen content of the beverage mixture mixed with CO₂ in a first (stripping gas) container to obtain an oxygen-reduced beverage mixture mixed with CO₂;

discharging the oxygen-reduced beverage mixture mixed with CO₂ from the first container;

determining the CO₂ content of the oxygen-reduced beverage mixture mixed with CO₂ (for example during or after the discharge in a discharge line of the first container); and

adding further CO₂ to the discharged, oxygen-reduced beverage mixture mixed with CO₂ on the basis of the determined CO₂ content to obtain a finally carbonated beverage (which can be packaged, for example into bottles or cans, in the further course of the process).

When oxygen-reduced water is mentioned, this can mean degassed water, i.e. for example water that has passed through a degassing means.

For example, the addition of the gas comprising CO₂, which can serve as a stripping gas in the oxygen reduction, to the beverage mixture to obtain the beverage mixture mixed with CO₂ can be accomplished such that the beverage mixture mixed with CO₂ is not saturated with CO₂. This in particular applies to the point where the gas is added or to the location where it flows into the first container or to an inlet valve of the first container.

That means, according to the invention, an at least two-stage carbonation takes place. In a first stage, CO₂ is supplied to a mixture of an oxygen-reduced water and a mixing component, wherein this CO₂ can in particular serve as a stripping gas for removing oxygen from the mixture. Oxygen that is introduced by the mixing component can, due to its generally lower viscosity compared to the mixing component itself (in particular in the case of syrup), better exit from the mixture than from the mixing component. Such an oxygen reduction is accomplished in a corresponding first container which, for example, can be placed under a vacuum of 0.7 to 0.9 bar absolute, for example. If the first container is placed under a vacuum, the amount of stripping gas (CO₂ and optionally one further gas component) added to the beverage mixture can be reduced since the vacuum facilitates a degassing of the oxygen. Moreover, flavour losses are reduced in the degassing of the mixture compared to a degassing of the mixing component alone. Moreover, by the use of oxygen-reduced water in the first container, less oxygen must be removed, thereby further reducing flavour losses.

The CO₂ content of the oxygen-reduced beverage mixture mixed with CO₂ can be determined by measuring the CO₂ content in the first container and/or after the discharge from the first container. For example, the CO₂ content of the oxygen-reduced beverage mixture mixed with CO₂ can be measured by a volume expansion method, an optical measuring method, or a membrane-based measuring method. By a measurement with the aid of a suited sensor, the CO₂ content, which essentially depends on the concrete composition and thus the CO₂ solubility of the beverage mixture, can be very precisely determined. The exact determination of the CO₂ content in turn permits an exact control of a further CO₂ supply for the desired final carbonation of the beverage mixture.

For example, the CO₂ content of the oxygen-reduced beverage mixture mixed with CO₂ exiting from the first container after the reduction of the oxygen content in the first container is determined and, depending on the determined amount of the CO₂ present in this mixture after it has exited from the first container, a final carbonation for the finished beverage is performed. Thus, the CO₂ content of the finished beverage to be packaged can be exactly and reliably controlled, whereby the CO₂ demand is reduced.

The provision of the oxygen-reduced water can comprise the degassing of the water in a second container placed under a vacuum, whereby in a simple and efficient way, the oxygen content of the finished beverage product can be reduced already before mixing water with the mixing component.

As mentioned, the first container can be placed under a vacuum to accelerate a degassing of oxygen from the beverage mixture mixed with CO₂. Both the vacuum of the first container and that of the second container can be generated by means of the same vacuum pump which can facilitate the complete course of the process. In particular, the vacuum pump can be a cleanable or CIP-capable vacuum pump.

According to a further embodiment of the method according to the invention, at least a portion of the discharged, oxygen-reduced beverage mixture mixed with CO₂ is returned into the first container, in particular via a circuit line. In this way, further oxygen reduction can be achieved during a repeated stay of the oxygen-reduced beverage mixture mixed with CO₂. According to a further embodiment, the measurement of the gas content of CO₂ and/or oxygen can be accomplished within the circuit line, in particular in line.

During the return into the first container, further CO₂ and/or N₂ can be added to the oxygen-reduced beverage mixture mixed with CO₂, which can serve as a stripping gas during the further oxygen reduction in the first container.

According to a further embodiment, the addition of the gas comprising CO₂ to the beverage mixture to obtain the beverage mixture mixed with CO₂, and the addition of the further CO₂ to obtain the finally carbonated beverage, are accomplished from the same CO₂ source, whereby the complete assembly of the plant used for carrying out the method can be facilitated.

Furthermore, according to a further embodiment of the method according to the invention, the beverage mixture and/or the beverage mixture mixed with CO₂ can be heated before the reduction of the oxygen content of the beverage mixture mixed with CO₂ in the first container, whereby the oxygen reduction in this container can be facilitated. Thereby, for example, the demand of stripping gas can also be decreased.

Moreover, not only the CO₂ content of the oxygen-reduced beverage mixture mixed with CO₂ exiting from the first container, but also its oxygen content can be determined. Depending on the residual oxygen content, a vacuum in the first container can be controlled. In this manner, a vacuum in the first container can be increased (that means the pressure in the first container is reduced) if the measurement of the residual oxygen content of the oxygen-reduced beverage mixture mixed with CO₂ shows, compared to a predetermined limiting value, an excessively high oxygen content in the oxygen-reduced beverage mixture mixed with CO₂ discharged from the first container. Furthermore, depending on the measured value for the residual oxygen content in the oxygen-reduced beverage mixture mixed with CO₂ discharged from the first container, the amount of CO₂ can be controlled during the addition of the gas comprising CO₂ to the beverage mixture to obtain the beverage mixture mixed with CO₂. It can thus be further ensured that in the final product, the desired degree of carbonation and the reduced oxygen content are obtained.

The above-mentioned object is also achieved by providing a device for manufacturing carbonated beverages, the device being configured to carry out the method according to any one of the preceding claims, and in particular by providing a filling line for packaging a carbonated beverage, in particular having such a device, the filling line comprising:

a mixing means (for example, a valve-controlled supply line from a reservoir for the mixing component) which is configured to mix oxygen-reduced water and a mixing component to provide a beverage mixture;

a first container for oxygen degassing of the beverage mixture mixed with CO₂ to provide an oxygen-reduced beverage mixture mixed with CO₂;

a first carbonation means configured to mix the beverage mixture with a gas containing CO₂ to provide the beverage mixture mixed with CO₂ and which is connected to a supply line connected to the first container;

a discharge line connected to the first container;

a first measuring means configured to measure a CO₂ content of the oxygen-reduced beverage mixture mixed with CO₂;

a second carbonation means connected to the discharge line; and

an open-loop/closed-loop control means configured to control the operation of the second carbonation means on the basis of the CO₂ content measured by the first measuring means.

The first measuring means can be at least partially arranged within the first container, or it can be connected to the discharge line.

A CO₂ source can be connected with the first and the second carbonation means.

Furthermore, the mentioned filling line can comprise a second container configured for degassing water to provide the oxygen-reduced water, and a (in particular cleanable) vacuum pump connected to the first and the second container to generate a vacuum in these containers.

Moreover, the filling line can comprise a second measuring means connected to the discharge line and configured to measure an oxygen content of the oxygen-reduced beverage mixture mixed with CO₂ in the first discharge line, wherein the open-loop/closed-loop control means can be configured to control, on the basis of the determined oxygen content, the vacuum pump and thus the vacuum of the first container, and/or the first carbonation means and thus the amount of the gas during the addition of the gas comprising CO₂ to the beverage mixture to obtain the beverage mixture mixed with CO₂.

According to a further embodiment, the filling line furthermore comprises a heating means arranged upstream of the first container in the process flow direction, and which is configured to heat the beverage mixture and/or the beverage mixture mixed with CO₂ before the reduction of the oxygen content of the beverage mixture mixed with CO₂ in the first container.

While in all of the above-described embodiments, the mentioned first container can be placed under a vacuum, an atmospheric pressure or overpressure can be present in the first container as an alternative in all above-described embodiments depending on the concrete application.

For the addition of gases or gas mixtures to liquids, such as beverage mixtures, in the sense of the invention, any devices known from prior art can be utilised or used, respectively, such as nozzles, e.g. Venturi nozzles.

The present invention also comprises the manufacture of beverages in which nitrous oxide (laughing gas) or a mixture of nitrous oxide and CO₂ is to be contained instead of CO₂. In this case, instead of CO₂, nitrous oxide or a mixture of nitrous oxide and CO₂ can be added to the beverage mixture.

Further features and exemplary embodiments as well as advantages of the present invention will be illustrated more in detail hereinafter with reference to the drawings. It will be understood that the embodiments do not exhaust the field of the present invention. It will be furthermore understood that some or all features described below may also be combined with each other in a different way.

### BRIEF DESCRIPTION OF THE FIGURES

FIG. 1 shows modules of a filling line according to an embodiment of the present invention.

FIG. 2 shows modules of a filling line according to a further embodiment of the present invention.

FIG. 3 shows a flow chart illustrating a method for the manufacture of a carbonated beverage according to an embodiment of the present invention.

FIG. 4 shows a flow chart illustrating a method for the manufacture of a carbonated beverage according to a further embodiment of the present invention.

### DETAILED DESCRIPTION

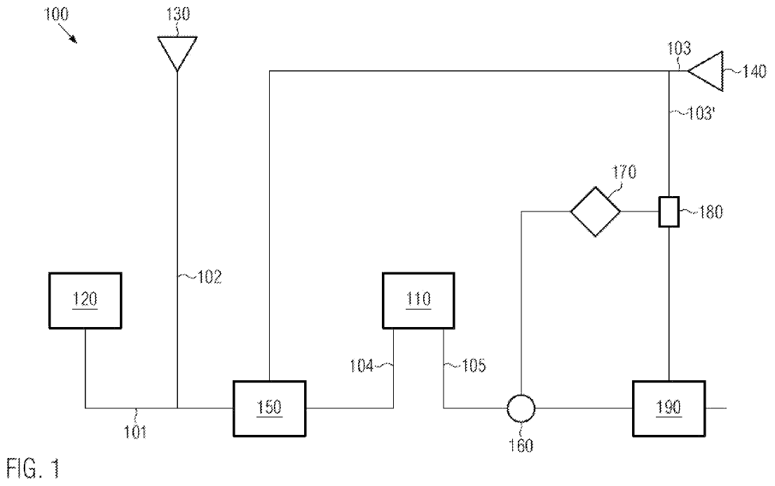

The present invention provides a method and a device as well as a filling line for the manufacture of beverages, in particular of low-oxygen, carbonated beverages. Here, an at least two-stage reduction of oxygen, i.e. first a reduction of oxygen in the water used for the beverage, and then a reduction of oxygen of a beverage mixture of the oxygen-reduced water and a selected mixing component, for example syrup, concentrate, flavour etc., is accomplished. Compared to prior art, a desired oxygen content and CO₂ content of the finished product provided for packaging can be achieved more reliably, and the amount of the stripping gas used for oxygen reduction can be reduced. One example of a device or filling line 100, respectively, for the manufacture of such beverages is shown in FIG. 1.

The filling line 100 shown in FIG. 1 comprises a first container (stripping gas container) 110 serving to reduce oxygen in a beverage mixture mixed with CO₂. In a second container 120, water serving to manufacture the beverage mixture mixed with CO₂ is degassed to reduce the oxygen content of the water (first oxygen reduction stage). The degassed water exits from the second container 120 via the line 101, and a mixing component (such as syrup, concentrate or flavours) is supplied to the degassed water from a reservoir 130 via the line 102. The line 102 can be provided with a corresponding mixing valve and can be considered as a mixing means with this valve. Furthermore, the filling line 100 comprises a CO₂ source 140 for delivering CO₂ via the line 103. The CO₂ source 140 can be supplemented by an N₂ source (not shown in FIG. 1). In a first carbonation means 150, which can comprise a control valve, CO₂ from the CO₂ source 140 (and optionally N₂) is supplied to the mixture of the degassed water supplied from the second container 120 and the mixing component delivered from the reservoir 130 (first carbonation stage).

The thus manufactured beverage mixture mixed with CO₂ is conducted via a line 104 into the first container 110 where a reduction of the oxygen content is effected by means of the CO₂ serving as a stripping gas (second oxygen reduction stage). Upon the reduction of the oxygen in the beverage mixture mixed with CO₂ in the first container 110, the beverage mixture exits from the first container 110 via the discharge line 105.

In the discharge line 105, a measuring means 160 is provided for measuring the CO₂ content of the oxygen-reduced beverage mixture mixed with CO₂ from the first container 110. However, it can be preferred to arrange the measuring means 160 at least partially within the first container for measuring the CO₂ content of the oxygen-reduced beverage mixture mixed with CO₂ in the first container 110. The measuring result is forwarded to an open-loop/closed-loop control means 170. This open-loop/closed-loop control means 170 can control a metering means 180, for example a control valve, through which CO₂ originating from the CO₂ source 140 can flow via a line 103′. This CO₂ can then be, on the basis of the measuring result delivered from the measuring means 160, added to the oxygen-reduced beverage mixture mixed with CO₂ in a second carbonation means 190 (second carbonation stage, final carbonation). The finally carbonated beverage mixture can then be supplied to a buffer tank and/or a filler (not shown in FIG. 1) for packaging, for example, in bottles or cans. The filler can be a filling machine which comprises a plurality of filling stations to simultaneously package a plurality of containers.

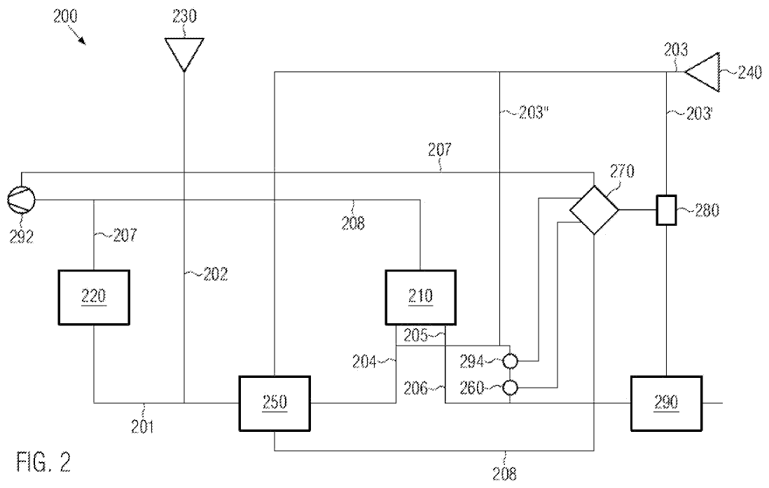

A further embodiment of a device or filling line 200, respectively, according to the invention is shown in FIG. 2. The filling line 200 shown in the figure comprises a first container (stripping gas container) 210 serving to reduce oxygen in a beverage mixture mixed with CO₂. In a second container 220, water serving to manufacture the beverage mixture mixed with CO₂ is degassed to reduce the oxygen content of the water (first oxygen reduction stage).

Both the degassing of the water in the second container 220 and the degassing of oxygen in the beverage mixture mixed with CO₂ in the first container 210 are accomplished under a vacuum which is effected by means of one single (in particular cleanable) vacuum pump 292 which is connected to the second container 220 via the line 207, and to the first container 210 via the line 208. The degassing of oxygen in the beverage mixture mixed with CO₂ in the first container 210 is effected, for example, under a vacuum of 0.7 to 0.9 bar. The choice of the vacuum in the first container 210 (stripping gas container) can be done depending on the beverage product, in particular the content and the composition of the volatile or taste-forming flavours. If relatively high (low) amounts of volatile flavours are present, a relatively low (high) vacuum is selected. Principally, by applying a vacuum, a higher volume flow rate into the stripping gas container can be achieved as compared to an atmospheric pressure with the same amount of CO₂ gas, whereby the degassing efficiency can be increased, the degassing efficiency being higher the higher the vacuum is.

The degassed water exits from the second container 220 via the line 201, and a mixing component (such as syrup, concentrate or flavours) is supplied to the degassed water from a reservoir 230 via the line 202. Furthermore, the filling line 200 comprises a CO₂ source 240 for delivering CO₂ via the line 203. The CO₂ source 240 can be supplemented by an N₂ source (not shown in FIG. 2). In a first carbonation means 250 which can comprise a control valve, CO₂ from the CO₂ source 240 (and optionally N₂) is supplied to the mixture from the degassed water delivered from the second container 220, and supplied to the mixing component delivered from the reservoir 230 (first carbonation stage).

The thus manufactured beverage mixture mixed with CO₂ is conducted via a line 204 into the first container 210 where a reduction of the oxygen content is effected (second oxygen reduction stage). Upon the reduction of the oxygen in the beverage mixture mixed with CO₂ in the first container 210, the beverage mixture exits from the first container 210 via the discharge line 205. The discharge line is part of a circuit line 206 via which at least a portion of the oxygen-reduced beverage mixture mixed with CO₂ can be returned into the first container 210 for further oxygen reduction.

In the circuit line 206, a measuring means 260 for measuring the CO₂ content of the oxygen-reduced beverage mixture mixed with CO₂ from the first container 210 is provided. As an alternative, the measuring means 260 can also be arranged in the discharge line 205, for example upstream of the second carbonation means 290. This can be advantageous if too much non-dissolved gas is present in the circuit line 206 which would render measurements more difficult. However, it can be preferred to arrange the measuring means 260 at least partially within the first container for measuring the CO₂ content of the oxygen-reduced beverage mixture mixed with CO₂ in the first container 210. The measuring result is forwarded to an open-loop/closed-loop control means 270. This open-loop/closed-loop control means 270 can cause a return of at least a portion of the oxygen-reduced beverage mixture mixed with CO₂ into the first container 210 or into the supply line 204 for further oxygen reduction on the basis of the measured value delivered by the measuring means 260 for the CO₂ content, for example via suited control valves. Furthermore, the open-loop/closed-loop control means 270 can control, depending on the measured CO₂ content, the pre-carbonation in the first carbonation means 250 via a control line 208. This open-loop/closed-loop control means 270 can moreover control a metering means 280, for example a control valve, through which CO₂ originating from the CO₂ source 140 can flow via a line 203′. This CO₂ can then be, on the basis of the measuring result delivered from the measuring means 260, added to the oxygen-reduced beverage mixture mixed with CO₂ in a second carbonation means 290 (second carbonation stage, final carbonation).

The finally carbonated beverage mixture can then be supplied to a buffer tank and/or a filler (not shown in FIG. 2) for packaging, for example, in bottles or cans. Moreover, via a line 203″, further CO₂ can be fed into the circuit line 206, if required. This line 203″ can be connected, as an alternative or in addition, to a source for another stripping gas, for example N₂.

Furthermore, a further measuring means 294 for measuring the oxygen content of the oxygen-reduced beverage mixture mixed with CO₂ from the first container 210 is incorporated in the circuit line 206. As an alternative, the measuring means 294 can also be arranged in the discharge line 205, for example upstream of the second carbonation means 290. This can be advantageous if too much non-dissolved gas is present in the circuit line 206 which would render measurements more difficult. This further measuring means 294 is also connected to the open-loop/closed-loop control means 270 to supply the latter with measuring results for the oxygen content. On the basis of these measuring results for the oxygen content of the oxygen-reduced beverage mixture mixed with CO₂, the open-loop/closed-loop control means 270 can control the operation of the vacuum pump 292 via a control line 207.

In the embodiment shown in FIG. 1 and in the embodiment shown in FIG. 2, a heating means can be incorporated, for example, in one or several ones of the lines 101, 201, 104, 204, for heating the degassed water or the beverage mixture before it is delivered into the first container 110, 210.

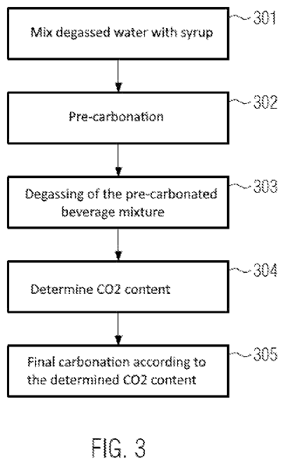

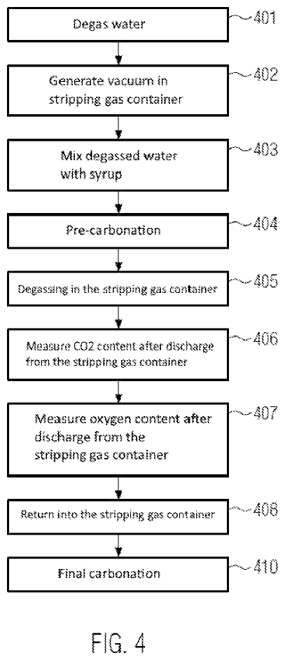

The devices/filling lines 100, 200 shown in FIGS. 1 and 2, or similar ones, can be used for carrying out an inventive method for the manufacture of a carbonated beverage. In FIGS. 3 and 4, exemplary embodiments of such a method which can be implemented in the devices/filling lines 100, 200 shown in FIGS. 1 and 2 are illustrated.

In the embodiment shown in FIG. 3, degassed water is mixed with syrup (or another mixing component) in step 301. The mixing ratio can be, for example, one proportion of syrup to 3 to 10 proportions of water. The mixture of degassed water and the mixing component is pre-carbonated 302 before it is conducted into a container for degassing 303. The pre-carbonation can be effected such that the total added CO₂, or only a portion thereof, is dissolved in the mixture of degassed water and syrup. Before the introduction into the container, heating can take place. The degassed, pre-carbonated beverage mixture is discharged from the container, and the CO₂ content of this discharged beverage mixture is determined 304. This determination of the CO₂ content can in particular be effected by measuring the same. Moreover, the determination of the CO₂ content of the beverage mixture can be effected by a corresponding measurement within the container. A final carbonation 305 of the beverage mixture is then effected according to the determined CO₂ content, such that the desired CO₂ content is achieved in the finished product to be packaged.

In the embodiment shown in FIG. 4, water is degassed in a container placed under a vacuum 401, and a vacuum is generated in a stripping gas container 402. The vacuum can be generated in both containers each with the same vacuum pump. The vacuum in the stripping gas container can be approximately 0.7 to 0.9 bar. In step 403, the degassed water is mixed with syrup (or another mixing component). In step 404, the mixture of degassed water and syrup is pre-carbonated by supplying CO₂ from a CO₂ source. The pre-carbonation can be effected such that the total added CO₂, or only a portion thereof, is dissolved in the mixture of degassed water and syrup. The pre-carbonated beverage mixture is degassed in the stripping gas container 405 to further reduce the oxygen content. Before the beverage mixture is introduced into the stripping gas container, it can be heated before or after the pre-carbonation 404.

Upon the degassing in the stripping gas container, the degassed pre-carbonated beverage mixture is discharged, and its CO₂ content is measured 406, and its oxygen content is measured 407. The measurement of the CO₂ content of the beverage mixture can be, as an alternative or in addition, effected within the container. The measuring results are forwarded to an open-loop/closed-loop control means. On the basis of the measuring results, the vacuum generated for degassing the water and the pre-carbonated beverage mixture and the amount of the CO₂ added during pre-carbonation 404 can be controlled. If the oxygen content measured downstream of the stripping gas container is too high, the pressure can be further reduced. Furthermore, on the basis of the measuring results, at least a portion of the degassed beverage mixture mixed with CO₂ can be returned to the stripping gas container for further degassing 408. This can be done while further adding stripping gas, such as further CO₂ or N₂ or sterile air. Finally, on the basis of the measuring results for the CO₂ content, a final carbonation 410 of the product to be filled is effected.

In the above-described methods and by means of the above-described modules of a filling line, the respectively generated amounts of finally carbonated finished beverages and altogether supplied CO₂ can be continuously monitored and separately summed up. The altogether supplied amount of CO₂ is composed of the residual amount of CO₂ in the beverage mixture downstream of the stripping gas container (corresponding to the difference between the amount of CO₂ supplied during pre-carbonation and the amount of CO₂ discharged in the stripping gas container) and the amount supplied during final carbonation. The amount of CO₂ supplied to the final carbonation can be controlled with high precision such that the sum ratio of the total CO₂ amount to the amount of the finished beverage corresponds to the desired final content of CO₂ in the finally mixed beverage. Here, it can be of advantage to reduce, at certain intervals or when certain sum values are reached, the respective sums (for the amount of CO₂ and the finished beverage) corresponding to a desired ratio of the amount of finished beverage to the amount of CO₂, whereby the measuring/control precision can be increased since even minor deviations can be recognised in the controlling process relative to the sums of the amounts due to the reduction thereof.

Furthermore, in all embodiments, the mass flow rate of the CO₂ serving as a stripping gas for the reduction of the oxygen content can be controlled by open-loop/closed-loop control utilising a pressure differential between the CO₂ gas pressure in a CO₂ source and the pressure in the stripping gas container by means of an actuator, such as a control valve. For the determination of the amount of the CO₂ serving as a stripping gas, one can take into consideration a prior charge of the degassed water which is pre-carbonated in the stripping gas container (for example in the first container 110 shown in FIG. 1, or in the second container 120 shown in FIG. 2), and is supplied, for example, from the second container 120 shown in FIG. 1, or the second container 220 shown in FIG. 2. This prior charge results from the degassing of the water provided in the second container 120 shown in FIG. 1, or in the second container 220 shown in FIG. 2, by means of CO₂, for example.

In the exemplary methods shown in FIGS. 3 and 4, individual process steps can be carried out in a sequence different from the one shown, if it is suited and desired.

While in all embodiments described with respect to FIGS. 1 to 4, the mentioned first container can be placed under a vacuum, an atmospheric pressure or an overpressure can prevail in the first container as an alternative in this embodiment depending on the concrete application.

1. A method for a manufacture of a carbonated beverage, including the steps of:
providing oxygen-reduced water;
mixing the oxygen-reduced water with a mixing component to obtain a beverage mixture;
adding a gas comprising CO₂ to the beverage mixture to obtain a beverage mixture mixed with CO₂;
reducing the oxygen content of the beverage mixture mixed with CO₂ in a first container to obtain an oxygen-reduced beverage mixture mixed with CO₂;
discharging the oxygen-reduced beverage mixture mixed with CO₂ from the first container;
determining the CO₂ content of the oxygen-reduced beverage mixture mixed with CO₂; and
adding further CO₂ to the discharged oxygen-reduced beverage mixture mixed with CO₂ on a basis of the determined CO₂ content to obtain a finally carbonated beverage.

2. The method according to claim 1, wherein the CO₂ content of the oxygen-reduced beverage mixture mixed with CO₂ is determined by measuring the CO₂ content in the first container, and/or after the discharge from the first container.

3. The method according to claim 1, wherein the CO₂ content of the oxygen-reduced beverage mixture mixed with CO₂ is measured by a volume expansion method, an optical measuring method, or a membrane-based measuring method.

4. The method according to claim 1, wherein a provision of the oxygen-reduced water comprises a degassing of the water in a second container placed under a vacuum.

5. The method according to claim 1, wherein the first container is placed under a vacuum.

6. The method according to claim 1, wherein the first container is placed under a vacuum and wherein the vacuum of the first container and the second container is generated by means of the same vacuum pump.

7. The method according to claim 1, wherein at least a portion of the discharged, oxygen-reduced beverage mixture mixed with CO₂ is returned to the first container.

8. The method according to claim 1, wherein at least a portion of the discharged, oxygen-reduced beverage mixture mixed with CO₂ is returned to the first container and furthermore with an addition of gas comprising CO₂ and/or N₂ to the oxygen-reduced beverage mixture mixed with CO₂ while it is being returned to the first container.

9. The method according to claim 1, furthermore with a heating of the beverage mixture and/or the beverage mixture mixed with CO₂ before the reduction of the oxygen content of the beverage mixture mixed with CO₂ in the first container.

10. A device for the manufacture of carbonated beverages, wherein the device is configured to carry out the method according to claim 1.

11. A filling line for packaging a carbonated beverage comprising:
a mixing means which is configured to mix oxygen-reduced water and a mixing component to provide a beverage mixture;
a first container for oxygen degassing of the beverage mixture mixed with CO₂ to provide an oxygen-reduced beverage mixture mixed with CO₂;
a first carbonation means configured to mix the beverage mixture with a gas containing CO₂ to provide the beverage mixture mixed with CO₂, and which is connected to a supply line connected with the first container;
a discharge line connected with the first container;
a first measuring means configured to measure a CO₂ content of the oxygen-reduced beverage mixture mixed with CO₂;
a second carbonation means connected with the discharge line; and
an open-loop/closed-loop control means configured to control an operation of the second carbonation means on the basis of the CO₂ content measured by the first measuring means.

12. The filling line according to claim 11, wherein the first measuring means is at least partially arranged within the first container or connected with the discharge line.

13. The filling line according to claim 11, furthermore with
a second container configured for degassing water to provide the oxygen-reduced water; and
a vacuum pump connected with the first container and the second container to generate a vacuum.

14. The filling line according to claim 11, furthermore with
a second measuring means which is connected to the discharge line and is configured to measure an oxygen content of the oxygen-reduced beverage mixture mixed with CO₂ in the first discharge line; and
wherein the open-loop/closed-loop control means is configured to control, on the basis of the determined oxygen content, the vacuum pump and thus the vacuum of the first container, and/or
the first carbonation means and thus the amount of gas during the addition of the gas comprising CO₂ to the beverage mixture to obtain the beverage mixture mixed with CO₂.

15. The filling line according to claim 11, wherein the first measuring means is at least partially arranged within the first container or connected with the discharge line and furthermore with a circuit line comprising the discharge line and connected to the first container, and a gas supply means configured to supply CO₂ and/or N₂ to the oxygen-reduced beverage mixture mixed with CO₂ conducted in the circuit line.

16. The filling line according to claim 11, furthermore with a heating means arranged upstream of the first container which is configured to heat the beverage mixture and/or the beverage mixture mixed with CO₂ before the reduction of the oxygen content of the beverage mixture mixed with CO₂ in the first container.
